(19) United States
(12) Patent Application Publication
(10) Pub. No.: US 2020/0036514 A1
(43) Pub. Date: Jan. 30, 2020

(54) DATA RECORDING AND RETRIEVAL USING AN OPERATIONAL TOKEN

(71) Applicant: TNT Blockchain Inc., Phoenix, AZ (US)

(72) Inventors: David E. Christensen, Peoria, AZ (US); Jamie Ray Zimmerman, Bella Vista (DO)

(21) Appl. No.: 16/048,204

(22) Filed: Jul. 27, 2018

(51) Int. Cl. H04L 9/06; H04L 9/32; H04L 29/06

(52) U.S. Cl. CPC H04L 9/0637; H04L 9/3213; H04L 9/3268; H04L 63/0823; H04L 9/3265

(57) ABSTRACT

An apparatus, system, and method are disclosed for data recording and retrieval on one or more blockchains using an operational token. One apparatus includes a processor and a memory storing code executable by the processor, wherein the processor receives a first request that contains input data and tag data. The processor stores the input data to a shared ledger of a first blockchain based on the tag data and generates an operation token corresponding to the first request. Here, the operation token associated the input data with a user and an operation identified corresponding to the stored input data. Additionally, the processor transmits the operation token to a user.

### FIELD

This invention relates to data stored on a blockchain network.

### BACKGROUND

A blockchain network includes multiple nodes for storing a decentralized, distributed, and public digital ledger used to record transactions. Many blockchain networks exist and more are being deployed. Due to the decentralized nature of blockchain networks, there is no coordination between the different networks.

### SUMMARY

Methods for managing data on a blockchain network are disclosed. Systems and apparatuses also perform the functions of the disclosed methods.

One method for managing data on a blockchain network includes receiving a first request that contains input data and tag data, storing the input data to a shared ledger of a first blockchain based on the tag data, generating an operation token corresponding to the first request, and transmitting the operation token to a user. Here, the operation token associates the input data with a user and an operation identifier corresponding to the stored input data.

Another method for managing data on a blockchain network includes receiving a request that includes an operation token, retrieving stored data from a shared ledger of a first blockchain, generating a certificate of authenticity based on the retrieved data, and transmitting the certificate of authenticity to a user.

A third method for managing data on a blockchain network includes receiving a first request and determining whether the first request includes an operation token. In response to the first request including an operation token, the method includes retrieving stored data from a location on the blockchain based on the operation token and generating a certificate of authenticity based on the stored data. Otherwise, in response to the first request not including the operation token, the method includes storing data included in the first request to a shared ledger of a blockchain and generating a second operation token in response to storing the data.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for managing data on a blockchain network;

FIG. 2 is a schematic block diagram illustrating another embodiment of a system for managing data on a blockchain network;

FIG. 3 is a schematic block diagram illustrating one embodiment of a token manager for managing data on a blockchain network;

FIG. 4 is a block diagram illustrating one embodiment of an operation token;

FIG. 5 is a block diagram illustrating one embodiment of a certificate of authenticity;

FIG. 6 is a flow chart diagram illustrating one embodiment of a procedure for managing data on a blockchain network;

FIG. 7 is a flow chart diagram illustrating one embodiment of a procedure for generating an operation token;

FIG. 8 is a flow chart diagram illustrating one embodiment of a procedure for generating a certificate of authenticity;

FIG. 9 is a block diagram illustrating one embodiment of a computer device for managing data on a blockchain network; and

FIG. 10 is a flow chart diagram illustrating one embodiment of a method for managing data on a blockchain network.

### DETAILED DESCRIPTION

Aspects of the present disclosure may be embodied as an apparatus, system, method, or computer program product. Accordingly, aspects of the present disclosure may take the form of an entirely software embodiment (including firmware, resident software, micro-code, or the like) or an embodiment combining software and hardware aspects that may all generally be referred to herein as a “circuit,” “module,” “apparatus,” or “system.” Furthermore, aspects of the present disclosure may take the form of a computer program product embodiment on one or more non-transitory computer-readable storage media storing computer-readable and/or executable program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented at least partially in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module.

Indeed, a module of executable code may include a single instruction, or many instructions, and may even be distributed over several different code segments, among different programs, across several memory devices, or the like. Where a module or portions of a module are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like.

In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

In addition, as used herein, the term “set” can mean “one or more,” unless expressly specified otherwise. The term “sets” can mean multiples of or a plurality of “one or mores,” “ones or more,” and/or “ones or mores” consistent with set theory, unless expressly specified otherwise.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description.

The description of elements in each figure may refer to elements of proceeding figures. Like numbers refer to like elements in all figures, including alternate embodiments of like elements.

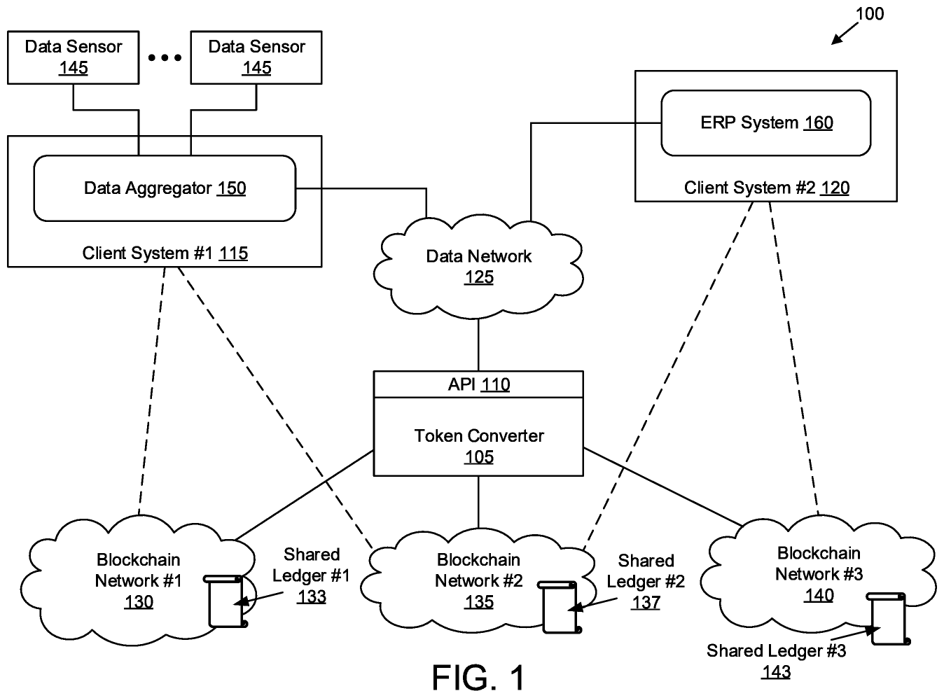

FIG. 1 depicts one embodiment of a system 100 for managing data on one or more blockchain networks. The system 100, in the depicted embodiment, includes a token converter 105 that is in communication with one or more clients over a data network 125 via an application programming interface (API) 110. One example of a client is the first client system 115. Another example of a client is the second client system 120. A client may be a software application, a user, a hardware computing device with a processor and memory, or another entity in communication with the token converter 105. In various embodiments, an Access Token is required to allow the client to interact with the token converter 105 via the API 110.

Moreover, the token converter 105 communicates with various blockchain networks to store and retrieve data. As depicted, the token converter 105 may communicate with a first blockchain network 130, a second blockchain network 135, and a third blockchain network 140. In various embodiments, a client may also communicate with one or more of the blockchain networks 130-140. Here, the first client system 115 has access to the first blockchain network 130 and the second blockchain network 135, while the second client system 120 has access to the second blockchain network 135 and the third blockchain network 140. In certain embodiments, one or more of the blockchain networks 130-140 may be private blockchain networks, while others of the blockchain networks 130-140 may be public blockchain networks.

In various embodiments, each blockchain network 130-140 is a peer-to-peer network that maintains a secure shared ledger (also referred to as a “distributed ledger”), which is a list of data transactions that have occurred in the past. This list of data transactions is organized into blocks linked together, thus the name “blockchain.” Each blockchain network 130-140 is composed of multiple (typically thousands) of blockchain nodes, every one of which maintains a copy of the shared ledger. Note that the first blockchain network 130 contains a single distributed ledger 133 shared among the nodes of the first blockchain network 130, the second blockchain network 135 contains a single distributed ledger 137 shared among the nodes of the second blockchain network 135, and the third blockchain network 140 contains a single distributed ledger 143 shared among the nodes of the third blockchain network 140. One advantage of such distributed ledger is improved security as it is almost impossible to hack the shared ledger because a hacker would have to change the contents of the shared ledger in the majority of blockchain nodes at the same time.

Various blockchain networks support so called “smart contracts.” A smart contract is a program that is stored as part of the shared ledger in all nodes of the blockchain network. Typically, a smart contract executes when prescribed conditions are met, e.g., when it receives a specific request, specific forms of data (parameters), etc. In response to meeting the prescribed conditions, the smart contract may perform various actions, such as returning information to the requester, invoke other smart contracts, etc. Note that a smart contract is essentially a distributed application: it exists in all nodes of the blockchain network and it is executed, e.g., simultaneously, in all blockchain nodes.

The token converter 105 coordinates interactions among multiple blockchain networks, including the illustrated blockchain networks 130-140. While specific numbers of clients and blockchain networks are depicted, other embodiments of the system 100 may include different numbers of clients and blockchain networks. The token converter 105 may service various requests made by the clients (including first client system 115 and second client system 120) to store data, to retrieve data, to validate data, and the like. In various embodiments, the token converter may interact with a smart contract on a blockchain network to service a request made by a client.

In general, the token converter 105 receives a first request, e.g., from a client, such as the first client system 115 and/or the second client system 120. Here, the first request may include input data (e.g., data to be stored to a blockchain network) and tag data. The tag data associated with the first request indicates where the input data is to be stored. In one embodiment, the tag data indicates specific ones of the blockchain networks 130-140 where the input data is to be stored. In other embodiments, the tag data indicates a specific user/client, wherein the token converter 105 associates the specific user/client with specific ones of the blockchain networks 130-140. In further embodiments, the tag data may indicate a specific project, product, or the like, where the token converter 105 associates the specific project/product with specific ones of the blockchain networks 130-140.

In certain embodiments, the input data is data received from the data aggregator 150 in the first client system 115. The data aggregator 150 receives sensor data from a variety of data sensors 145. Examples of data sensors 145 include, but are not limited to: temperature sensors, humidity sensors, location sensors (e.g., GPS receivers), and the like. In various embodiments, the data sensors 145 provide data relating to a product being produced by the first client. Thus, the data aggregator 150 in the first client system 115 receives, aggregates, and formats the sensor data. Moreover, as the sensor data may be used to validate the provenance and/or suitability of the product, the first client system 115 may desire to store the aggregated sensor data on a blockchain network. To do so, the first client system 115 sends a storage request to the token converter 105, the storage request including input data (e.g., data to be stored) and tag data, as described above. According to the depicted embodiment, the input data may be sensor readings provided by the data aggregator 150. In other embodiments, the input data may be files, documents, inventory lists, or other information needing to be stored.

Accordingly, the token converter 105 accesses the appropriate one (or ones) of the blockchain networks 130-140 and stores the input data to a shared ledger (e.g., based on the tag value in the request). For example, if the tag data indicates the first client system 115 is associated with both the first blockchain network 130 and the second blockchain network 135, then the token converter 105 initiates blockchain transactions with both the first blockchain network 130 and the second blockchain network 135 to store a copy of the input data in the shared ledgers 133, 137 of both blockchain networks. Note that the token converter 105 may initiate blockchain transactions with the relevant blockchain network concurrently or sequentially.

In some embodiments, the token converter 105 converts a data format of the input data prior to storing on the blockchain network. For example, certain blockchain networks may expect data to be in certain formats. In other embodiments, certain clients may expect data to be in certain formats. Based on these expectations, the token converter 105 may convert the input data into a specific format for storage on a blockchain network.

After completing the blockchain transaction(s) triggered by the request, the token converter 105 generates an operation token corresponding to the first request. As used herein, an “operation” refers to an action involving one or more blockchain networks triggered by a request. Each operation has an identifier, for example generated by the token converter 105. An operation token includes an operation identifier corresponding to the operation and one or more blockchain tokens Thus, when a request triggers blockchain transactions on multiple blockchain networks, the corresponding operation token will include multiple blockchain tokens. Moreover, the operation token may associate the input data with a user/client, a project, a product, or the like (e.g., based on the tag value).

A blockchain token is representative of the data operation involving a specific blockchain. In the system 100, a blockchain token represents the blockchain transaction (e.g., storing data to the blockchain network) and indicates a location on the blockchain network where the data is located. Here, the blockchain token may be correlated with a specific transaction identifier used by the blockchain network. The blockchain token is specific to the blockchain network involved, thus a blockchain token generated by the first blockchain network 130 will be different than the blockchain token generated by the second blockchain network 135 for the same data operation.

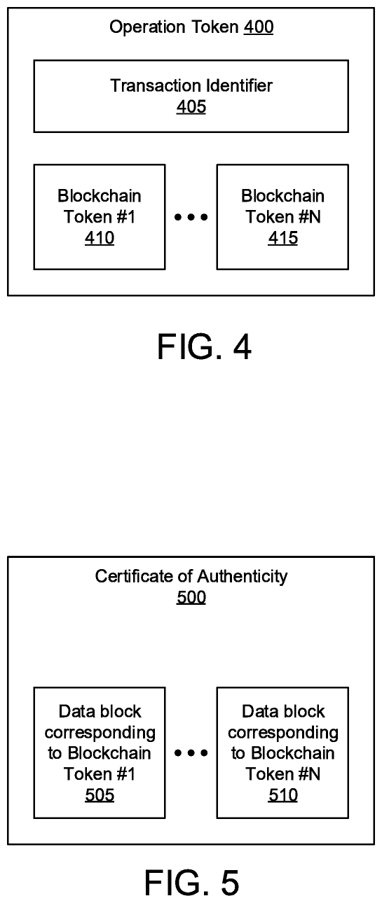

After generating the operation token, the token converter 105 transmits the operation token to a user based on the tag value. In one embodiment, the token converter 105 returns the operation token to the requester. In another embodiment, the token converter 105 returns the operation token to another device/system associated with the user making the request. Here, the token converter 105 may acknowledge the request and/or indicate the success (or failure) of the operation to the requester without providing the operation token to the requester. In further embodiments, the token converter 105 may send the operation token to a different user/client than the one requesting the data operation, again based on the tag value. For example, the requester may be a first client that is a supplier to second client. Here, the operation token may be transmitted to both the first client and the second client. Alternatively, the operation token may be transmitted only to the second client. One example of an operation token is described with reference to FIG. 4.

In some embodiments, the token converter 105 receives a validation request from a client, for example from the ERP system 160 of the second client system 120. Here, the validation request is a different type of request than the above-mentioned storage request (e.g., it invokes a different type of operation). In various embodiments, the validation request includes one or more operation tokens. The validation request may also include tag data. Here, the token converter 105, upon receiving the validation request, uses the included operation token(s) to retrieve the data corresponding to the operation token(s) from one or more of the blockchain networks 130-140. As discussed, an operation token includes one or more blockchain tokens, each blockchain token indicating a location on a blockchain network.

The token converter 105 retrieves stored data from a shared ledger on an indicated blockchain network. For example, the operation token included in the validation request may point to data stored on the third blockchain network 140. Accordingly, the token converter 105 retrieves store data from the third shared ledger 143. Moreover, the token converter 105 generates a certificate of authenticity based on the stored data. Here, the ERP system 160 may manage delivery merchandise for the second client. As an example, the operation tokens included in the validation request may correspond to tracking data stored on the blockchain, or other data usable to validate delivery merchandise.

After generating the certificate of authenticity, the token converter 105 returns the certificate to the second client, for example transmitting the certificate to the ERP system 160. In certain embodiments, the token converter 105 may append the certificate of authenticity to one or more documents used by the ERP system 160. Note that the relevant documents may also be stored on a blockchain network, such as the third blockchain network 140. Accordingly, the document and data delivered via certificate of authenticity may function as a proof of delivery for the ERP system 160. In one embodiment, blockchain transaction identifiers may be appended to the preferred delivery document.

Note that other entities/systems may also access any of the blockchain networks 130-140. Accordingly, the certificate of authenticity may be independently verified by a client or other entity.

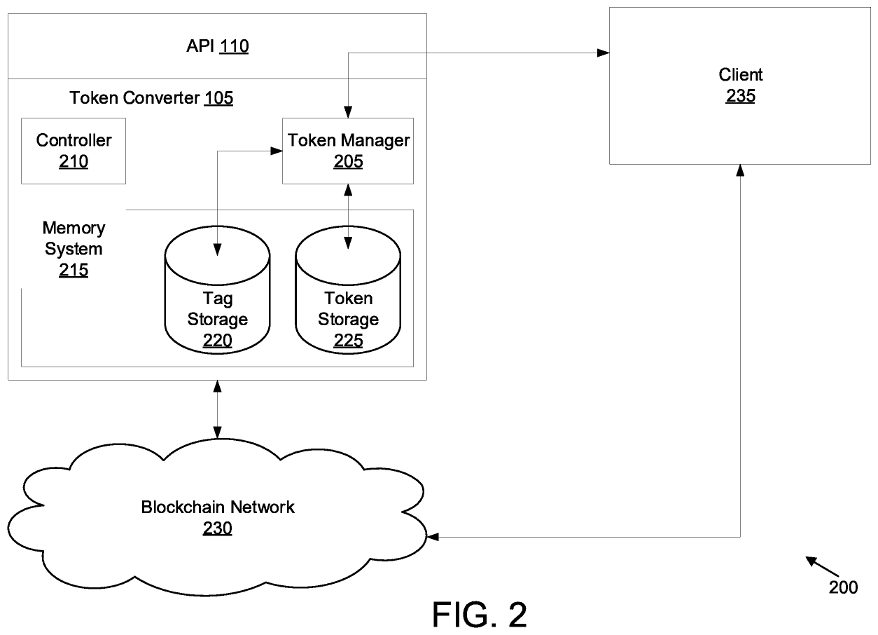

FIG. 2 depicts a system 200 for managing data on a blockchain network, according to embodiments of the disclosure. The system 200 is a simplified embodiment of the system 100 described above. The system 200 includes the token converter 105 and its API 110, a blockchain network 230, and a client 235. In the depicted embodiment, the token converter 105 includes a token manager 205, a controller 210, and a memory system 215. The memory system 215 includes various databases, including a tag storage to 220 and a token storage 225.

The tag storage 220 stores information about the various tags used by the token converter 105. In various embodiments, tags may be dynamically created by a client. One example of the tag is a data string preceded by a hashtag symbol. Here, each tag may indicate a participant (e.g., client, customer, supplier, and the like), a project (e.g., a product line, a product type, an order being fulfilled, and the like), or the like. Moreover, a project or product tag may be associated with multiple participants Likewise, a participant tag may be associated with multiple projects and/or products. As new projects/participants are added, a client may dynamically generate new tags. The tag storage 220 stores these associations.

Moreover, the tag storage 220 may store various preferences, accounts, profiles, and other information relevant to a participant, project, or product. Notably, a tag may indicate which blockchains (e.g., which of the blockchain networks 130-140) are to be used. In general, a tag may indicate where data is to be located (e.g., which blockchains), who data is associated with (e.g., which participants/clients), what projects/products are associated with the data, and the like. Moreover, tags do not need to be globally unique, rather they may be unique to each container or data space. Thus, different clients may use the same tags in the same or in a different manner.

The token storage 225 stores information about the various tokens created and managed by the token converter 105. In certain embodiments, the token storage 225 stores the tokens indefinitely. For example, a token may only be deleted by the creator (e.g., the client requesting the operation that results in the token) or purged by an administrator of the token converter 105. As discussed above an operation token represents an operation performed by the token converter 105. The operation token includes one or more blockchain tokens. Moreover, the blockchain tokens represent blockchain transaction identifiers. In general, a transaction identifier has a very long string. In contrast, a token is a pointer referencing the identifier.

The token manager 205 manages the creation, storage, and transfer of tokens in the token converter 105. In some embodiments, the token manager 205 creates an operation token in response to the token converter 105 storing data to the blockchain network 230 (e.g., performing storage operation). For example, in response to the client 235 sending a storage request containing the data. The data provided by the client 235 may be sensor readings, documents, associations between sensor readings and documents, and the like. In other embodiments, the token manager 205 identifies tokens in the request and retrieves data corresponding to the tokens.

In certain embodiments, the token manager 205 validates a request by the client 235, for example verifying an IP address, account information, passphrase, etc. of the client 235. As discussed in greater detail below, the token manager 205 may service various types of requests, including an Authentication request, a Generate Access Token request, a Write request, a Read request, and the like.

The controller 210 controls operation of the token converter 105. In various embodiments, the controller 210 may include any known controller capable of executing computer-readable instructions and/or capable of performing logical operations. For example, the controller 210 may be a microcontroller, a microprocessor, a central processing unit (“CPU”), a graphics processing unit (“GPU”), an auxiliary processing unit, a field programmable gate array (“FPGA”), or similar programmable controller. In some embodiments, the controller 210 executes instructions stored in the memory system 215 to implement the token manager 205. The controller 210 is communicatively coupled to the various components of the token converter 105, including the memory system 215.

The memory system 215, in one embodiment, comprises one or more computer readable storage media. In some embodiments, the memory system 215 includes volatile computer storage media. For example, the memory system 215 may include a RAM, including dynamic RAM (“DRAM”), synchronous dynamic RAM (“SDRAM”), and/or static RAM (“SRAM”). In some embodiments, the memory system 215 includes non-volatile computer storage media. For example, the memory system 215 may include a hard disk drive, a flash memory, or any other suitable non-volatile computer storage device. In some embodiments, the memory system 215 includes both volatile and non-volatile computer storage media. In certain embodiments, the memory system 215 also stores program code and related data, such as an operating system or other controller algorithms operating on the token converter 105.

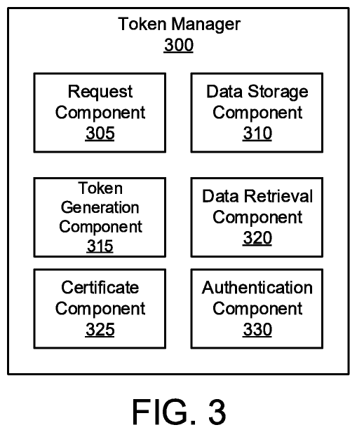

FIG. 3 depicts one embodiment of a token manager 300 for managing data on a blockchain network, according to embodiments of the disclosure. The token manager 300 may be one embodiment of the token manager 205 discussed above. More generally, a token manager 300 may be implemented on a token converter 105. In the depicted embodiment, the token managed 300 includes a request component 305, a data storage component 310, a token generation component 315, a data retrieval component 320, a certificate component 325, and an authentication component 330.

The request component 305, in one embodiment, is configured to parse a request received from a client, such as the client 235. Here, the request component 305 determines the type of request, for example whether the client 235 is requesting a data storage operation, requesting a certificate of authentication, and the like. In one embodiment, the request may be an Authentication Request for generating a certificate of authentication. In one embodiment, the request may be a Generate Access Token Request for generating a new access token (e.g., access credentials) to use on the API 110. Note that the Access Token may be used by a client to show they are authorizes to use the token manager 300 (and/or token converter 105).

In one embodiment, the request may be a List Blockchain Request used to obtain a list of all the blockchain networks configured by a client. In one embodiment, the request may be a Write Blockchain Request for storing (writing) data onto the clients configured blockchain network(s). Note that tag data may be used to associate the Write Blockchain Request with particular blockchain networks. In one embodiment, the request may be a Read Request used to retrieve (read) data of a blockchain using a token (e.g., operation token) generated by a token converter, such as a token converter 105 implementing the token manager 300. In another embodiment, the request may be a Read Native Request for reading data of a blockchain using the native ID of the transaction (e.g., using the blockchain token generate by the blockchain network where the data is stored).

Moreover, the request component 305 identifies tag data in the request, input data in the request, operation (or blockchain) tokens in the request, or other parameters of the request. In one embodiment, the request component 305 may comprise logic hardware, such as a controller, a field-programmable gate array (FPGA) or other programmable logic, firmware for an FPGA or other programmable logic, microcode for execution on a microcontroller, an application-specific integrated circuit (ASIC), or the like. In another embodiment, the request component 305 may comprise executable software code, such as a device driver or the like, stored on the memory system 215 for execution on the controller 210. In a further embodiment, the request component 305 may include a combination of both executable software code and logic hardware.

The data storage component 310, in one embodiment, is configured to store data received in request (e.g., input data) to one or more blockchain networks based on the values of the tag data included in the request. In certain embodiments, the data storage component 310 identifies one or more blockchain networks associated with a user identified by the tag data. In other embodiments, the tag data itself may indicate the one or more blockchain networks.

The data received (e.g., input data) may belong to one of a variety of data types. A first data type includes sensor readings and other sensor data. The readings may be provided by a data aggregator, such as the data aggregator 150. A second data type includes documents. These documents may include agreements between different parties (e.g., contracts), supply chain documents used by the ERP system 160 (including quotes, sales orders, invoices, shipping notifications, order status inquiries, bills of lading, return merchandise authorizations, credit/debit adjustments, warehouse stock transfer, warehouse inventory records, proof of deliveries, and the like). In certain embodiments, documents stored on the blockchain may be generated using a smart contract in the blockchain network. A third data type is a collection object that associates data blocks with one another. For example, a collection object may indicate that five documents and five hundred sensor readings are all related (e.g., belong to a collection).

Having identified the blockchain network(s) to which data is to be written, the data storage component 310 interacts with the blockchain network(s) e.g., using an external blockchain API, to store the data. This triggers a transaction on the blockchain network(s) where the data is written to the shared ledger(s) of the blockchain network(s). The data storage component 310 may identify a blockchain transaction identifier corresponding to the data storage operation. In one embodiment, the data storage component 310 may comprise logic hardware, such as a controller, a field-programmable gate array (FPGA) or other programmable logic, firmware for an FPGA or other programmable logic, microcode for execution on a microcontroller, an application-specific integrated circuit (ASIC), or the like. In another embodiment, the data storage component 310 may comprise executable software code, such as a device driver or the like, stored on the memory system 215 for execution on the controller 210. In a further embodiment, the data storage component 310 may include a combination of both executable software code and logic hardware.

The token generation component 315, in one embodiment, is configured to generate an operation token corresponding to a request to store data on a blockchain network. Here, the operation token may include one or more blockchain tokens, each blockchain token representative of a blockchain transaction. Moreover, the operation token may include an operation identifier. In certain embodiments, the operation token includes tag data, for example as received in the request.

In certain embodiments, the token generation component 315 may generate a relationship token. Here, the relationship token describes an association between various tokens (e.g., operation tokens and/or blockchain tokens). Note that an operation token may be a type of relationship token because the operation token indicates blockchain tokens from different blockchains refer to the same operation (e.g., data storage operation). However, the relationship tokens may indicate that several operation tokens are related to each other and the like.

In one embodiment, the token generation component 315 may comprise logic hardware, such as a controller, a field-programmable gate array (FPGA) or other programmable logic, firmware for an FPGA or other programmable logic, microcode for execution on a microcontroller, an application-specific integrated circuit (ASIC), or the like. In another embodiment, the token generation component 315 may comprise executable software code, such as a device driver or the like, stored on the memory system 215 for execution on the controller 210. In a further embodiment, the token generation component 315 may include a combination of both executable software code and logic hardware.

The data retrieval component 320, in one embodiment, is configured to retrieve data from one or more blockchain networks based on a retrieval request (e.g., a Read request, or Read Native request). One example of a retrieval request is a request to generate a certificate of authenticity (e.g., an Authentication request). Here, the request includes one or more tokens, such as an operation token or a blockchain token. The data retrieval component 320 identifies locations on the blockchain storing the requested data, e.g., based on the one or more tokens included in the retrieval request. As described above, an operation token may include one or more blockchain tokens, each blockchain token associated with a specific blockchain network. Accordingly, the data retrieval component 320 performs data retrieval from each blockchain network associated with the operation token.

In one embodiment, the data retrieval component 320 may comprise logic hardware, such as a controller, a field-programmable gate array (FPGA) or other programmable logic, firmware for an FPGA or other programmable logic, microcode for execution on a microcontroller, an application-specific integrated circuit (ASIC), or the like. In another embodiment, the data retrieval component 320 may comprise executable software code, such as a device driver or the like, stored on the memory system 215 for execution on the controller 210. In a further embodiment, the data retrieval component 320 may include a combination of both executable software code and logic hardware.

The certificate component 325, in one embodiment, is configured to generate a certificate of authenticity, for example upon request of the user (e.g., the client 235). Here, the retrieved data corresponding to one or more operation tokens provided by the user is used to generate the certificate of authenticity. One example of a certificate of authenticity is described below with reference to FIG. 5. In one embodiment, the certificate component 325 may comprise logic hardware, such as a controller, a field-programmable gate array (FPGA) or other programmable logic, firmware for an FPGA or other programmable logic, microcode for execution on a microcontroller, an application-specific integrated circuit (ASIC), or the like. In another embodiment, the certificate component 325 may comprise executable software code, such as a device driver or the like, stored on the memory system 215 for execution on the controller 210. In a further embodiment, the certificate component 325 may include a combination of both executable software code and logic hardware.

The authentication component 330, and one embodiment, is configured to authenticate a request from user, for example confirming that the user is a subscriber of the token manager 300. For example, the authentication component 330 may verify an IP address, account information, passphrase, etc. of the requester. As another example, the authentication component 330 may validate an Access Token included with the request. Upon authenticating the request, the data storage component 310, the token generation component 315, the data retrieval component 320, and/or the certificate component 325 will perform the requested actions. In one embodiment, the authentication component 330 may comprise logic hardware, such as a controller, a field-programmable gate array (FPGA) or other programmable logic, firmware for an FPGA or other programmable logic, microcode for execution on a microcontroller, an application-specific integrated circuit (ASIC), or the like. In another embodiment, the authentication component 330 may comprise executable software code, such as a device driver or the like, stored on the memory system 215 for execution on the controller 210. In a further embodiment, the authentication component 330 may include a combination of both executable software code and logic hardware.

FIG. 4 depicts one example of an operation token 400, according to embodiments of the disclosure. An operation token 400 includes a transaction identifier 405 and one or more blockchain tokens. Here, the depicted operation token 400 contains N blockchain tokens, from a first blockchain token 410 up to an Nth blockchain token 415. In one embodiment, the operation token includes one or more blockchain identifiers identifying a blockchain network where the data is stored. In certain embodiments, the one or more blockchain tokens are used to identify the blockchain network(s) where the data is stored.

The operation token 400 may be generated in response to a user request to perform a storage operation on one or more blockchain networks. Here, each of the blockchain tokens 410-415 belongs to a different blockchain network. Note that each blockchain token includes a blockchain transaction identifier specific to the blockchain network. Each operation token 400 is a unique token due to the unique transaction identifier 405. Moreover, each blockchain token 410-415 is unique to the blockchain producing the token (e.g., due to the unique blockchain transaction identifier). In certain embodiments, the operation token 400 may include a timestamp corresponding to the operation and/or a data type of the input data. In one embodiment, the blockchain transaction identifiers include a timestamp corresponding to the operation.

FIG. 5 depicts one example of a certificate of authenticity 500, according to embodiments of the disclosure. As discussed above, a client may request a certificate of authenticity 500 and provide one or more operation tokens. Here, the certificate of authenticity 500 includes one or more data blocks corresponding to the operation token(s). In the depicted embodiment, the certificate of authenticity 500 includes a first data block 505 corresponding to the first blockchain token, up to an Nth data block 510 corresponding to an Nth blockchain token. Note that an operation token includes one or more blockchain tokens. Here, the data blocks 505-510 may comprise the actual data values represented by the blockchain tokens.

In various embodiments, the certificate of authenticity 500 is appended to one or more documents used by suppliers, contractors, manufacturers, and the like. Here, the appended certificate of authenticity 500 offers proof using the data stored on the blockchain. For example, at the certificate of authenticity 500 may include data blocks corresponding to sensor readings of location, temperature, etc. thereby proving the provenance, timely delivery, proper storage/transportation methods, or the like of a product being delivered to a customer. Because of the immutable nature of data stored on a blockchain, the certificate of authenticity 500 may include blockchain tokens (or blockchain transaction identifiers) so that a customer and/or client may independently verify the data.

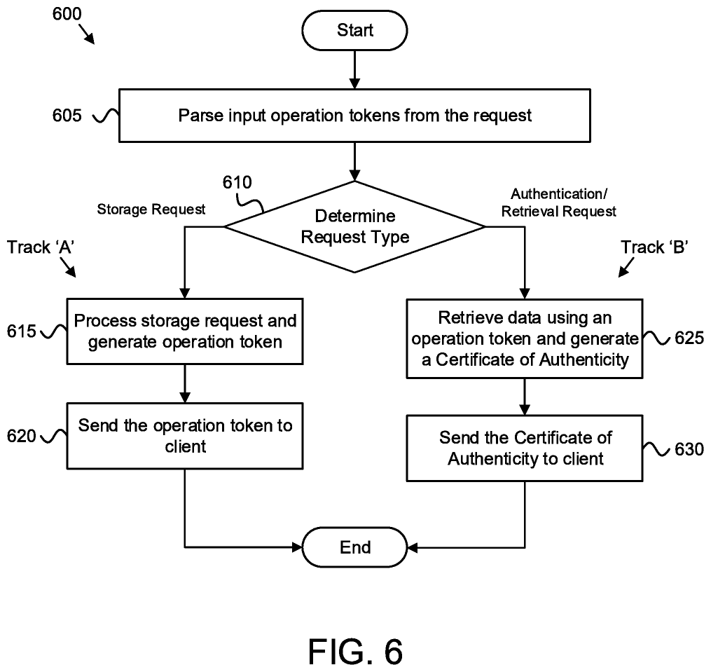

FIG. 6 depicts an operational flow chart 600 for managing data on a blockchain network by a server, according to embodiments of the disclosure. In various embodiments, the operation depicted in the flowchart 600 may be performed by a token converter 105, or component thereof. The operation begins as the server, e.g., implemented by the token converter 105, receives a request from a client (see block 605). In various embodiments, the server may authenticate the request, e.g., verify that the center is a client, that the client's account/subscription allows for the requested action, and the like. The request includes various parameters. In one embodiment, the request includes a tag data. Here the tag data may indicate a client or user associated with a request. In another embodiment, the tag data may indicate a project or product associated with request.

Next, the server determines the type of request. Specifically, the server determines whether the received request is a storage request (see decision block 610). In one embodiment, different request types contain different formats, wherein the format of the request indicates its type. In another embodiment, tag data included in the request indicates its type. In still another embodiment, the inclusion or absence of certain types of parameters indicates the type request. For example, a request including data (or links to data) may indicate a data storage request, whereas a request including operation tokens may indicate a validation request.

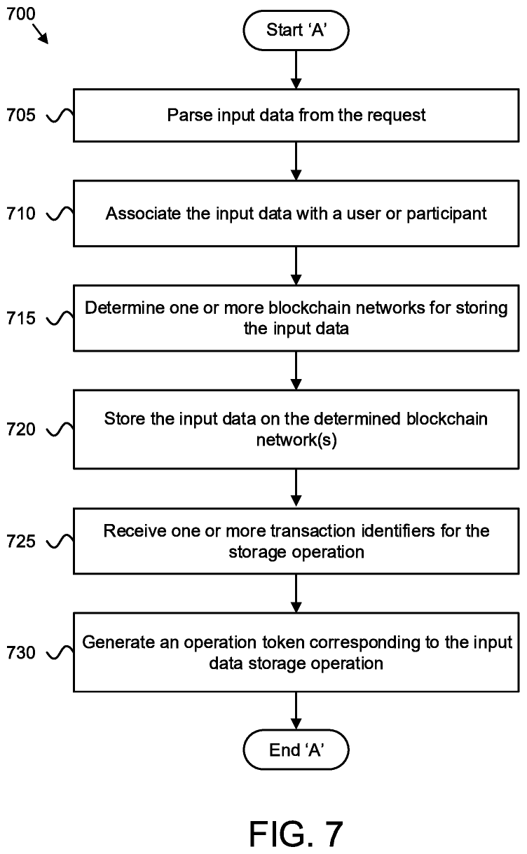

If the server determines the request is a storage request, the operation moves to track ‘A’ and proceeds to process the storage request and generate an operation token corresponding to the storage request (see block 615). One embodiment of processing the storage request and generating the operation token is described with reference to FIG. 7. Having generated the operation token, the server sends the generated token to the client (see block 620). Alternatively, or additionally, the server may send the operation token to one or more entities tagged as participants (e.g., in the tag data of the received request). For example, a supplier may store tracking data to the blockchain and have the resulting operation token sent to its client.

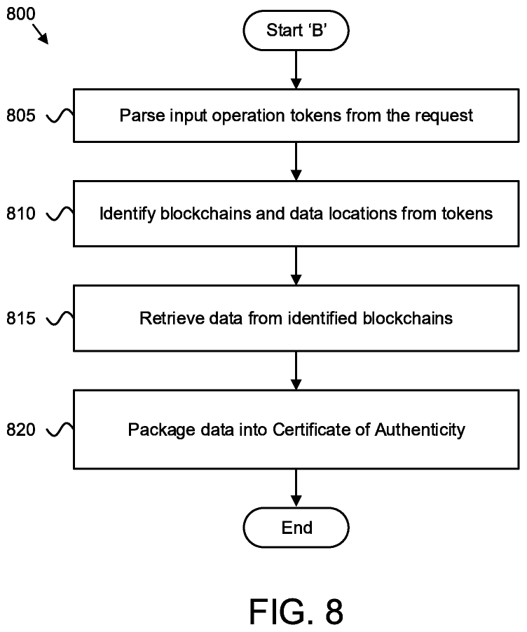

However, if the server determines that the request is not a storage request, for example due to the request including one or more operation tokens, then the operation moves to track ‘B’ and proceeds to retrieve data corresponding to the provided tokens and generate a certificate of authenticity (see block 625). One embodiment of retrieving data corresponding to the provided tokens and generating a certificate of authenticity is described with reference to FIG. 8. The server also sends the certificate of authenticity to the client (see block 630). Alternatively, or additionally, the server may send the certificate of authenticity to one or more entities tagged as participants (e.g., in the tag data of the received request).

Means for receiving a request from a client, in various embodiments, may include one or more of a token converter 105, a token manager 205, a controller 210, a token manager 300, a request component 305, a CPU or other microprocessor, an FPGA, an ASIC, other logic hardware, and/or other executable code stored on a computer-readable storage medium. Other embodiments may include similar or equivalent means for receiving a request from a client.

Means for determining a type of request, in various embodiments, may include one or more of a token converter 105, a token manager 205, a controller 210, a token manager 300, a request component 305, a CPU or other microprocessor, an FPGA, an ASIC, other logic hardware, and/or other executable code stored on a computer-readable storage medium. Other embodiments may include similar or equivalent means for determining a type of request.

Means for storing data on a blockchain network, in various embodiments, may include one or more of a token converter 105, a token manager 205, a controller 210, a token manager 300, a data storage component 310, a CPU or other microprocessor, an FPGA, an ASIC, other logic hardware, and/or other executable code stored on a computer-readable storage medium. Other embodiments may include similar or equivalent means for storing data on a blockchain network.

Means for retrieving data from a blockchain network, in various embodiments, may include one or more of a token converter 105, a token manager 205, a controller 210, a token manager 300, a data retrieval component 320, a CPU or other microprocessor, an FPGA, an ASIC, other logic hardware, and/or other executable code stored on a computer-readable storage medium. Other embodiments may include similar or equivalent means for retrieving data from a blockchain network.

Means for generating an operation token, in various embodiments, may include one or more of a token converter 105, a token manager 205, a controller 210, a token manager 300, a token generation component 315, a CPU or other microprocessor, an FPGA, an ASIC, other logic hardware, and/or other executable code stored on a computer-readable storage medium. Other embodiments may include similar or equivalent means for generating an operation token.

Means for generating a certificate of authenticity, in various embodiments, may include one or more of a token converter 105, a token manager 205, a controller 210, a token manager 300, a certificate component 325, a CPU or other microprocessor, an FPGA, an ASIC, other logic hardware, and/or other executable code stored on a computer-readable storage medium. Other embodiments may include similar or equivalent means for generating a certificate of authenticity.

Means for sending an operation token or a certificate of authenticity, in various embodiments, may include one or more of a token converter 105, a token manager 205, a controller 210, a token manager 300, a request component 305, a CPU or other microprocessor, an FPGA, an ASIC, other logic hardware, and/or other executable code stored on a computer-readable storage medium. Other embodiments may include similar or equivalent means for sending an operation token or a certificate of authenticity.

FIG. 7 depicts a procedure 700 for generating an operational token by a server, according to embodiments of the disclosure. In various embodiments, the procedure 700 may be performed by a token converter 105, or component thereof. The procedure 700 may be one implementation of track ‘A’ described in FIG. 6. The procedure 700 begins as the server, e.g., implemented by the token converter 105, parses input data from a request received from a client (see block 705). Here, the input data may be sensor readings, documents, collection objects, or any other data to be stored.

Next, the server associates the input data in the request with a user or participant (see block 710). In various embodiments, the request may include a tag data. Here the tag data may indicate a client or user associated with a request, and thus to be associated with the input data. In another embodiment, the tag data may indicate a project or product associated with request, wherein the project/product has a previously determined relationship to a client or user.

The server determines one or more blockchain networks for storing the input data (see block 715). In various embodiments, the tag data in the request indicates the one or more blockchain networks. In certain embodiments, each defined project, product, and/or participant may be associated with a set of blockchain networks.

The server also stores the input data on the determines blockchain network(s) (see block 720). Optionally, the server may format the input data prior to storing it on the blockchain network(s). For example, a certain participant may want the data to be in a certain format, wherein the server converts the input data to have the certain format. As another example, a project or product may require a certain format. In certain embodiments, a blockchain network may require the data to be in a certain format. Thus, the step of storing the input data may include formatting the input data.

Upon storing the input data, the server receives one or more transaction identifiers for the involved blockchain networks (see block 725). Here, the transaction identifier is unique to the blockchain network. Moreover, the one or more transaction identifiers may correspond to one or more blockchain tokens.

Next, the server generates an operation token corresponding to the input data storage operation (see block 730). As discussed above, the operation token may include one or more blockchain tokens that correspond to the storage of the input data on a blockchain network.

Means for parsing the input data, in various embodiments, may include one or more of a token converter 105, a token manager 205, a controller 210, a token manager 300, a request component 305, a data storage component 310, a CPU or other microprocessor, an FPGA, an ASIC, other logic hardware, and/or other executable code stored on a computer-readable storage medium. Other embodiments may include similar or equivalent means for parsing the input data.

Means for associating the input data in the request with a user or participant, in various embodiments, may include one or more of a token converter 105, a token manager 205, a controller 210, a token manager 300, a request component 305, a data storage component 310, a CPU or other microprocessor, an FPGA, an ASIC, other logic hardware, and/or other executable code stored on a computer-readable storage medium. Other embodiments may include similar or equivalent means for associating the input data with a user or participant.

Means for determining the one or more blockchain networks for storing the input data, in various embodiments, may include one or more of a token converter 105, a token manager 205, a controller 210, a token manager 300, a request component 305, a data storage component 310, a CPU or other microprocessor, an FPGA, an ASIC, other logic hardware, and/or other executable code stored on a computer-readable storage medium. Other embodiments may include similar or equivalent means for determining a blockchain network.

Means for storing the input data on a determined blockchain network, in various embodiments, may include one or more of a token converter 105, a token manager 205, a controller 210, a token manager 300, a data storage component 310, a CPU or other microprocessor, an FPGA, an ASIC, other logic hardware, and/or other executable code stored on a computer-readable storage medium. Other embodiments may include similar or equivalent means for storing the input data on a determine blockchain network.

Means for receiving a transaction identifier, in various embodiments, may include one or more of a token converter 105, a token manager 205, a controller 210, a token manager 300, a data storage component 310, a token generation component 315, a CPU or other microprocessor, an FPGA, an ASIC, other logic hardware, and/or other executable code stored on a computer-readable storage medium. Other embodiments may include similar or equivalent means for receiving a transaction identifier.

Means for generating an operation token, in various embodiments, may include one or more of a token converter 105, a token manager 205, a controller 210, a token manager 300, a token generation component 315, a CPU or other microprocessor, an FPGA, an ASIC, other logic hardware, and/or other executable code stored on a computer-readable storage medium. Other embodiments may include similar or equivalent means for generating an operation token.

FIG. 8 depicts a procedure 800 for generating a certificate of authenticity by a server, according to embodiments of the disclosure. In various embodiments, the procedure 800 may be performed by a token converter 105, or component thereof. The procedure 800 may be one implementation of track ‘B’ described in FIG. 6. The procedure 800 begins as the server, e.g., implemented by the token converter 105, parses input operation tokens from a request received from a client (see block 805). Next, the server identifies one or more blockchains storing data corresponding to the operation tokens from the input tokens (see block 810).

The server retrieves stored data from the identifies one or more blockchain networks (see block 815). The server also packages the retrieved data into a certificate of authenticity (see block 820). In various embodiments, the certificate of authenticity may be based on stored data corresponding to many operation tokens.

Means for parsing the input operation tokens, in various embodiments, may include one or more of a token converter 105, a token manager 205, a controller 210, a token manager 300, a request component 305, a data retrieval component 320, a CPU or other microprocessor, an FPGA, an ASIC, other logic hardware, and/or other executable code stored on a computer-readable storage medium. Other embodiments may include similar or equivalent means for parsing the input operation tokens.

Means for identifying blockchains and data locations from the input tokens, in various embodiments, may include one or more of a token converter 105, a token manager 205, a controller 210, a token manager 300, a request component 305, a data retrieval component 320, a CPU or other microprocessor, an FPGA, an ASIC, other logic hardware, and/or other executable code stored on a computer-readable storage medium. Other embodiments may include similar or equivalent means for identifying blockchains and data locations from the input tokens.

Means for retrieving the stored data from identified blockchain network(s), in various embodiments, may include one or more of a token converter 105, a token manager 205, a controller 210, a token manager 300, a data storage component 310, a CPU or other microprocessor, an FPGA, an ASIC, other logic hardware, and/or other executable code stored on a computer-readable storage medium. Other embodiments may include similar or equivalent means for retrieving the stored data.

Means for generating a certificate of authenticity, in various embodiments, may include one or more of a token converter 105, a token manager 205, a controller 210, a token manager 300, a token generation component 315, a CPU or other microprocessor, an FPGA, an ASIC, other logic hardware, and/or other executable code stored on a computer-readable storage medium. Other embodiments may include similar or equivalent means for generating a certificate of authenticity.

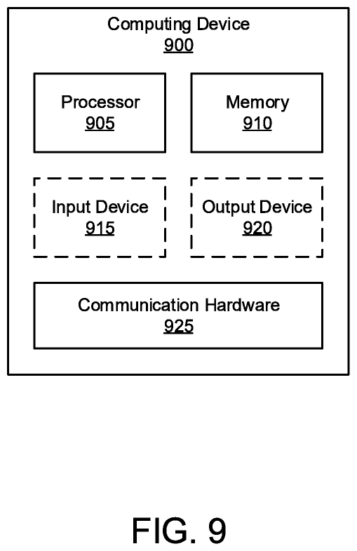

FIG. 9 depicts a computer device 900 for managing data on a blockchain network, according to embodiments of the disclosure. The computer device 900 may be embodied in the token converter 105. In addition, the computer device 900 may be embodied in the token manager 205. In the depicted embodiment, the computer device 900 includes a processor 905, a memory 910, and communication hardware 925. In various embodiments, the computer device 900 may include an input device 915 and/or an output device 920.

The processor 905 may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910. The processor 905 is communicatively coupled to the memory 910, input device 915, output device 920, and communication hardware 925. The processor 905 may be embodied in the controller 210.

The memory 910 may be a semiconductor storage device, a hard disk drive, an optical storage device, a micromechanical storage device, or combinations thereof. The memory 910 may store code. The processor 905 may execute the code. The memory 910 may be embodied in the memory system 215. The communication hardware 925 may communicate with other devices. For example, the communication hardware 925 may communicate via the data network 125. As another example, the communication hardware 925 may use an external blockchain interface to communicate with one or more of the blockchain networks 130-140.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, may include any known electronically controllable display or display device. The output device 920 may be designed to output visual, audible, and/or haptic signals. In some embodiments, the output device 920 includes an electronic display capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

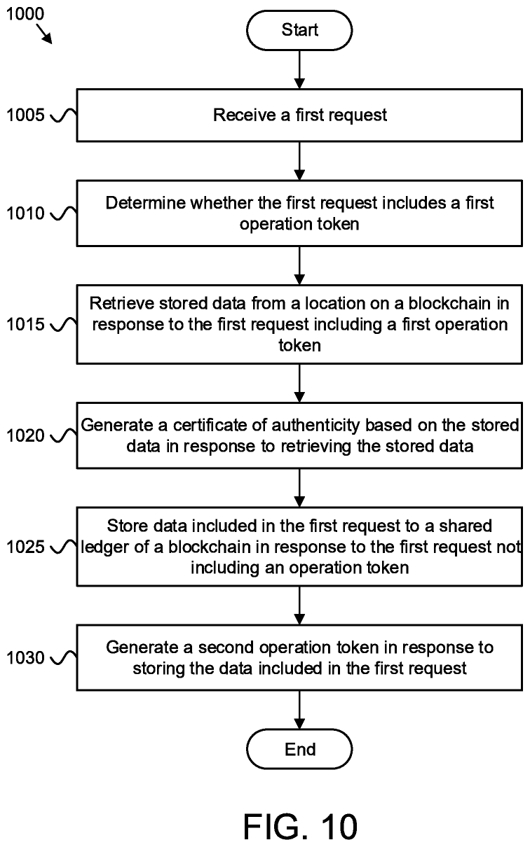

FIG. 10 depicts a method 1000 for managing data on a blockchain network, according to embodiments of the disclosure. In one embodiment, the method 1000 begins and the request component 305 receives 1005 a first request. Here, the first request may be received from client. In certain embodiments, the first request may include tag data associating the first request with a one or more clients, users, participants, projects, products, or the like.

Means for receiving the first request, in various embodiments, may include one or more of a token converter 105, a token manager 205, a controller 210, a token manager 300, a request component 305, a CPU or other microprocessor, an FPGA, an ASIC, other logic hardware, and/or other executable code stored on a computer-readable storage medium. Other embodiments may include similar or equivalent means for receiving the first request.

Additionally, the method 1000 includes the request component 305 determining 1010 whether the first request includes a first operation token. Here, first operation token corresponds to a previously performed storage operation. In certain embodiments, the first operation token includes one or more blockchain transaction tokens. In various embodiments, a request including an operation token is a request to generate a certificate of authenticity using stored data corresponding to the included operation token.

Means for determining whether the first request includes a first operation token, in various embodiments, may include one or more of a token converter 105, a token manager 205, a controller 210, a token manager 300, a request component 305, a CPU or other microprocessor, an FPGA, an ASIC, other logic hardware, and/or other executable code stored on a computer-readable storage medium. Other embodiments may include similar or equivalent means for determining whether the first request includes a first operation token.

Additionally, the method 1000 includes the data retrieval component 320 retrieving stored data from a location on a blockchain in response to the first request including the first operation token. Here, the operation token includes information about which blockchain to retrieve the data from. Moreover, the operation token may include an indication of the location on the blockchain where the data is located.

Means for retrieving stored data from a location on a blockchain, in various embodiments, may include one or more of a token converter 105, a token manager 205, a controller 210, a token manager 300, a data retrieval component 320, a CPU or other microprocessor, an FPGA, an ASIC, other logic hardware, and/or other executable code stored on a computer-readable storage medium. Other embodiments may include similar or equivalent means for retrieving stored data from a location on a blockchain.

Additionally, the method 1000 includes the certificate component 325 generating 1020 a certificate of authenticity based on the stored data. Here, generation of the certificate of authenticity occurs in response to the retrieval of the data stored on the blockchain(s). One example of a certificate of authenticity is discussed above with reference to FIG. 5.

Means for generating a certificate of authenticity, in various embodiments, may include one or more of a token converter 105, a token manager 205, a controller 210, a token manager 300, a certificate component 325, a CPU or other microprocessor, an FPGA, an ASIC, other logic hardware, and/or other executable code stored on a computer-readable storage medium. Other embodiments may include similar or equivalent means for generating a certificate of authenticity.

Additionally, the method 1000 includes the data storage component 310 storing 1025 data included in the first request to a shared ledger of a blockchain in response to the first request not including an operation token. Here, the absence of an operation token in the first request may indicate that the request is a storage request. Accordingly, data included in the first request is stored 1025 to one or more blockchain networks.

In certain embodiments, tag data included in the first request is used to select one or more blockchain networks for storing the data. Each blockchain network will have its own shared ledger. In various embodiments, the data storage component 310 uses an external API of a selected blockchain network to store the data onto the blockchain. Note that the storage operation (e.g., transaction) for each blockchain network will result in a blockchain transaction identifier and corresponding blockchain transaction token.

Means for storing data included in the first request to a shared ledger of a blockchain, in various embodiments, may include one or more of a token converter 105, a token manager 205, a controller 210, a token manager 300, a request component 305, a CPU or other microprocessor, an FPGA, an ASIC, other logic hardware, and/or other executable code stored on a computer-readable storage medium. Other embodiments may include similar or equivalent means for storing data included in the first request to a shared ledger of a blockchain.

Additionally, the method 1000 includes the token generation component 315 generating 1030 an operation token corresponding to the storage operation. Here, the generated operation token is labeled a “second token” to distinguish from any operation tokens provided as input parameters in the first request. In some embodiments, the second operation token includes one or more blockchain transaction tokens produces in response to storing the data on the blockchain network(s). One example of an operation token is discussed above with reference to FIG. 4.

Means for generating an operation token, in various embodiments, may include one or more of a token converter 105, a token manager 205, a controller 210, a token manager 300, a token generation component 315, a CPU or other microprocessor, an FPGA, an ASIC, other logic hardware, and/or other executable code stored on a computer-readable storage medium. Other embodiments may include similar or equivalent means for generating an operation token.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a first request, the first request comprising input data and tag data the tag data identifying a user, a data input type, and a first blockchain;
initiating a blockchain transaction to store the input data to a shared ledger of a first blockchain, the first blockchain identified using the tag data;
generating an operation token in response to completion of the blockchain transaction, wherein the operation token associates the input data with a user identified using the tag data and an operation identifier corresponding to the blockchain transaction storing the input data; and
transmitting the operation token to a user.

2. The method of claim 1, wherein the tag data of the first request indicates a plurality of blockchains, the plurality of blockchains including the first blockchain and at least one additional blockchain, the method further comprising initiating at least one additional blockchain transaction to store the input data to a shared ledger of each additional blockchain.

3. The method of claim 2, wherein the operation token further associates the input data with a blockchain transaction identifier for each blockchain where the input data is stored.

4. The method of claim 1, wherein the operation token further associates the stored data with a timestamp and a data type identified using the tag data.

5. The method of claim 4, wherein the data type is one of: a sensor reading, a document, and a collection, wherein input data corresponding to a collection associates at least one sensor reading with at least one document.

6. The method of claim 1, further comprising:
associating the first request with a user based on the tag data, wherein the first request is received from a first entity and the operation token is transmitted to a second entity associated with the user, different than the first entity.

7. The method of claim 1, further comprising formatting the input data to a format used by the first blockchain.

8. The method of claim 1, further comprising registering with a plurality of blockchains, the plurality of blockchains including the first blockchain, wherein the tag data indicates the first blockchain.

9. The method of claim 1, further comprising:
receiving a second request from a requester, the second request comprising a blockchain token;
retrieving stored data corresponding to the blockchain token from the shared ledger of a blockchain corresponding to the blockchain token;
generating a certificate of authenticity based on the retrieved data; and
transmitting the certificate of authenticity to the requester.

10. The method of claim 9, wherein the certificate of authenticity comprises data values represented by the blockchain token.

11. A method comprising:
receiving a request, the request comprising an operation token;
retrieving stored data from a shared ledger of a first blockchain indicated by the operation token;
generating a certificate of authenticity based on the retrieved data; and
transmitting the certificate of authenticity to a user.

12. The method of claim 11, wherein the operation token includes a first blockchain token that indicates a location on the first blockchain of the stored data.

13. The method of claim 12, wherein the first blockchain token further indicates a timestamp and a data type.

14. The method of claim 13, wherein the data type is one of: a sensor reading, a document, and a collection, wherein input data corresponding to a collection associates at least one sensor reading with at least one document.

15. The method of claim 11, wherein the operation token includes a plurality of blockchain tokens, each blockchain token being associated with one of a plurality of blockchains, the plurality of blockchains including the first blockchain.

16. The method of claim 11, wherein the certificate of authenticity comprises data values represented by the second blockchain token.

17. A method comprising:
receiving a first request;
determining whether a first request includes a first operation token;
retrieving stored data from a location on a blockchain in response to the first request including a first operation token;
generating a certificate of authenticity based on the stored data in response to retrieving the stored data;
storing data included in the first request to a shared ledger of a blockchain in response to the first request not including a first operation token; and
generating a second operation token in response to storing the data included in the first request.

18. The method of claim 17, wherein the certificate of authenticity comprises data values represented by the first operation token.

19. The method of claim 17, wherein the first request includes tag data and does not include the first operation token, wherein the tag data indicates a plurality of blockchains, wherein the plurality of blockchains includes the blockchain and at least one second blockchain, the method further comprising storing the input data to a shared ledger of each second blockchain.

20. The method of claim 19, wherein the second operation token includes a plurality of blockchain tokens, each blockchain token generated in response to storing the input data on a corresponding blockchain.
